(19) United States
(12) Patent Application Publication
(10) Pub. No.: US 2025/0004275 A1
(43) Pub. Date: Jan. 2, 2025

(54) BACKLIGHT-FREE AUGMENTED REALITY USING DIGITAL HOLOGRAPHY

(71) Applicant: NVIDIA Corp., Santa Clara, CA (US)

(72) Inventors: Jonghyun Kim, San Francisco, CA (US); Ward Lopes, San Jose, CA (US); David Luebke, Charlottesville, VA (US)

(73) Assignee: NVIDIA Corp., Santa Clara, CA (US)

(21) Appl. No.: 18/744,378

(22) Filed: Jun. 14, 2024

Related U.S. Application Data
(60) Provisional application No. 63/524,222, filed on Jun. 30, 2023.

(51) Int. Cl. G02B 27/01; G02B 27/28; G03H 1/22; G06T 19/00

(52) U.S. Cl. CPC G02B 27/0172; G02B 27/283; G03H 1/2294; G06T 19/006; G01B 2290/70; G02B 2027/0174; G02B 2027/0178

(57) ABSTRACT

Optical systems including an interferometer utilizing a spatial light modulator. A light guide including a first beam splitter and multiple mirrors directs incoherent light through the beam splitter to the interferometer to generate an interference light pattern, and further directs the interference light pattern back to the first beam splitter via the mirrors.

### CROSS-REFERENCE TO RELATED APPLICATIONS

This application claims priority and benefit under 35 USC 119(e) to application Ser. No. 63/524,222, filed on Jun. 30, 2023, titled “Backlight-Free Augmented Reality Using Digital Holography”, the contents of which are incorporated herein by reference in their entirety.

### BACKGROUND

There exists a need for compact implementation of optical occlusion in augmented reality (AR) displays. Conventional AR displays typically implement optical occlusion, if at all, using heavy folded optics. Conventional implementations may have undesirable attributes such as blocking the user's face from outside (to reduce inbound light intensity) or suffer low contrast due to using a bright background.

Conventionally, optical occlusion may be achieved using an spatial light modulator (SLM) to block the light in a per-pixel manner. These solutions may utilize imaging optics from the outside plane to the SLM plane, and optics to image the SLM plane to a ‘far’ plane for correct perception. The resulting implementations tend to be bulky and heavy.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B depict examples of a system utilizing backlight-free augmented reality display with Self-Interference Incoherent Digital Holography.

FIG. 2 depicts a U-Net convolutional neural network structure in one embodiment.

FIG. 3A-FIG. 3D depict light propagation and interference through an optical apparatus in one embodiment.

FIG. 4 depicts an example of the elements of the optical system embodiment depicted in FIG. 3A-FIG. 3D deployed in a head-mounted display apparatus.

### DETAILED DESCRIPTION

Disclosed herein are subtractive augmented reality mechanisms that generate display images by blocking incident light (occlusion) instead of adding light from additional light sources, saving power and weight.

Spatial light modulators (SLMs) enable precise control and manipulation of light in the spatial domain. An SLM modulates the phase, amplitude, and/or polarization of incident light. This modulation may be achieved by configuring the optical properties of materials within the SLM. There are different types of SLMs, including liquid crystal-based SLMs, digital micromirror devices (DMDs), and ferroelectric-based SLMs.

Liquid crystal-based SLMs are one commonly used type. Liquid crystal-based SLMs utilize an array of liquid crystal cells that may be individually controlled. Each cell acts as a pixel in the SLM. These liquid crystal cells are configured to modify the phase of incident light passing through them by applying an electric field. When an electric field is applied to a liquid crystal cell, the alignment of liquid crystal molecules within the cell changes. This change in molecular alignment alters the refractive index of the liquid crystal material, causing a corresponding change in the phase of the incident light passing through that pixel. By independently controlling the voltage applied to each liquid crystal cell, the phase of the incident light may be modified on a per-pixel basis across the entire SLM surface. This modulation allows for the creation of complex patterns, images, and wave-fronts.

In one aspect, the disclosed optical systems utilize a trained neural network model configured using a holographic camera-in-the loop process. Holographic cameras record both the phase and intensity of incident light, enabling reconstruction of a 3D image depicting depth features of the scene. Holographic cameras commonly utilize a coherent light source such as a laser, split into two a reference beam and an object beam. The object beam illuminates the object(s) to record. Light scattered from the object carries information about its shape and depth characteristics. The reference bream and the light scattered from the object meet and interfere on a recording medium (e.g., a digital sensor). The interference pattern created by the mingling of these two beams encodes the phase and intensity information from the scene. The recorded phase and intensity information are sufficient to reconstruct a 3D image of the object.

In another aspect, the disclosed optical systems may utilize an interferometer, e.g., a Michelson interferometer, that splits incident light into two paths, reflecting each path off a mirror, and then recombining light from the two paths. The incident light passes through a beam splitter (e.g., a half-mirror), which divides the light into two beams. One beam travels in one direction (the reference arm), and the second beam travels in a perpendicular direction (the sample arm). In one arm, a mirror reflects the beam back towards the beam splitter. In the other arm, an SLM also reflects the beam back towards the beam splitter, with an applied phase shift in selected region(s). The selected regions of the SLM are configured to alter the optical path length of the reflected light, altering its phase. The two reflected beams re-combine at the half-mirror into light for a composite image.

The recombined light creates an interference pattern. For regions of the image where the path lengths are of equal length, the light from reflected from the mirror and the light reflected from the SLM interferes constructively (generating brighter areas in the composite image). In the selected regions where the path length varies, the two reflected beams interfere destructively (generating darker areas in the composite image) depending on the extent of the phase differences.

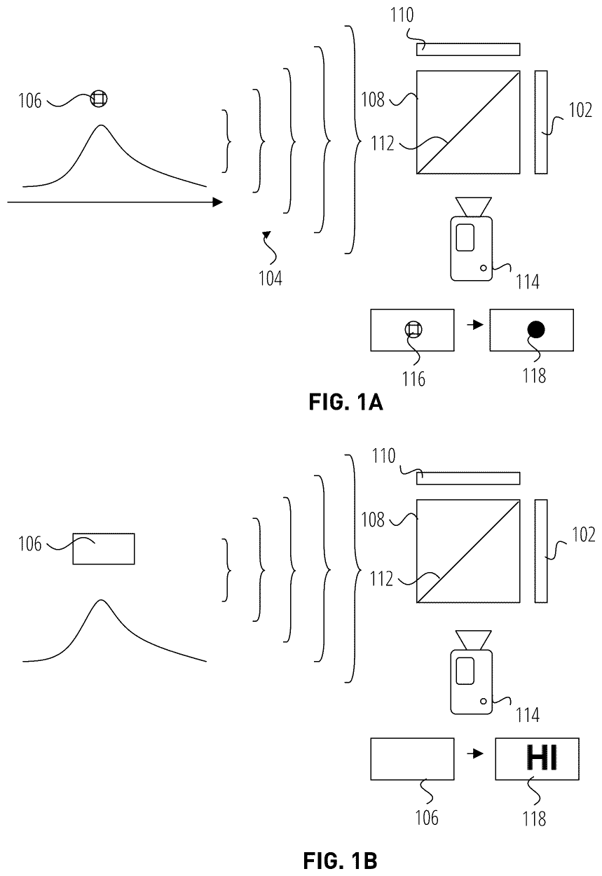

FIG. 1A and FIG. 1B depict examples of a system utilizing a backlight-free augmented reality display with Self-Interference Incoherent Digital Holography. Because the system does not utilize a backlight, it may consume less power than conventional backlit augmented reality display mechanisms.

Self-Interference Incoherent Digital Holography (SIDH) utilizes a phase-adjusting spatial light modulator 102 configured to destructively self-interfere incoherent incident light wavefronts 104 from a region 106 of the outside environment, which may in some cases be a physical object in the environment. In one configuration, a phase spatial light modulator 102 is located along one arm of an Interferometer 108 and a mirror 110 is located equidistant along the other arm of the interferometer as depicted in FIG. 1A. Incoming light is split by a half-mirror 112 or other beam splitting mechanism and the split beams are reflected back from the mirror 110 and spatial light modulator 102, where they recombine and pass to a camera 114.

A target region 116 to occlude, corresponding to the region 106 of the environment, is identified in the captured scene. A camera 114 captures the interference pattern generated by the interferometer 108. A phase shift is applied to cause destructive interference in the target region 116, resulting in an occluded image region 118. The target region 116 and resulting occluded image region 118 may comprise complex and non-contiguous regions, for example as depicted in FIG. 1B.

A neural network may be configured via camera-in-the-loop (CITL) training to infer the SLM settings to generate the occlusions. The training process involves adjusting the neural network's internal parameters (weights and activations) to minimize prediction errors for optimal SLM settings, based on a loss function. The neural network's predictions during training are compared against desired occlusion results. If there is a discrepancy that exceeds desired performance constraints, the network's parameters are adjusted and improved through additional training. Eventually the network reaches an acceptable level of inference performance and training concludes. A CITL neural network model trained in this manner learns to infer the phase shift needed to occlude objects or areas in a scene at different distances from the user's point of view.

Because the neural network is trained using the actual optics that will be deployed, its training accounts for non-linear distortions in those optics. The utilized camera 114 may be a holographic camera that senses phase information about objects in the scene as well as the pixel values.

Augmented reality display devices may utilize SIDH to occlude areas in the user's field of view targeted for content display, for example displaying content on a wall by destructively interfering with the light from the target region(s) only. This precise selectivity may enable significantly reduced power consumption in AR devices.

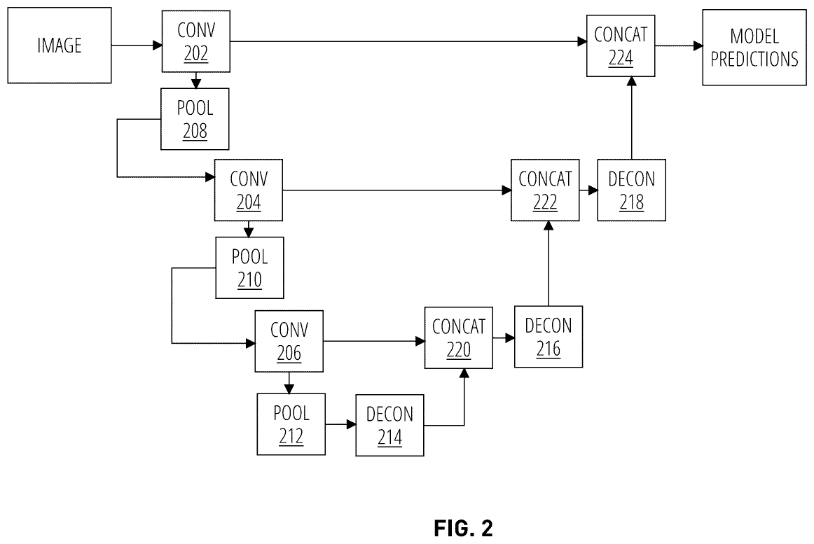

FIG. 2 depicts a U-Net convolutional neural network structure in one embodiment. The network comprises a contracting path and an expansive path. The contracting path comprises repeated application of (downsampling) convolutions 202, 204, 206 . . . Following each convolution, a rectified linear unit activation (ReLU, not depicted) and a pooling operation 208, 210, 212 (e.g., max pooling) may be applied. During the contraction, the spatial information of the input image is reduced while feature information is increased. The expansive pathway combines the feature and spatial information through a sequence of deconvolutions 214, 216, 218 . . . (i.e., transpose convolutions) and concatenations 220, 222, 224 . . . with high-resolution features from the contracting path. The expansive path provides localization combined with contextual information from the contracting path.

A convolution layer applies filters to the input to produce feature maps that are typically of lower resolution (due to stride and pooling operations). A deconvolution layer applies a convolutional operation to spatially upscale the feature maps, increasing their resolution. The deconvolution layer may achieve this by padding the input feature maps before applying a convolutional operation. During training, the deconvolution layers learn the upsampling filters that best reconstruct or enhance the spatial dimensions of the input feature maps.

The deconvolution layers in the expansive path each increase the size of the feature maps, combined with concatenation with the corresponding feature map from the contracting path via skip connections. Upsampling and concatenation with high-resolution features from the contracting path enables the network to localize and delineate the boundaries of objects in the input image, for example.

In a free-space wave propagation model such as Fresnel propagation or Angular spectrum propagation, most of the wave propagates from one plane to another plane without misalignment or non-linear behavior. The neural network model trained using a holographic CITL learns the misalignment and non-linear behavior of incident light at the SLM plane and at other optical components (e.g., at beam splitters). For example, a model trained using holographic CITL may learn that for a particular augmented reality display apparatus, there exists a particular lateral misalignment at the SLM plane, a phase level error for some SLM pixels, or particular degree of tilt at a particular beam splitter. The model may then generate predictions or settings to compensate for the effect of these distortions on the SLM output.

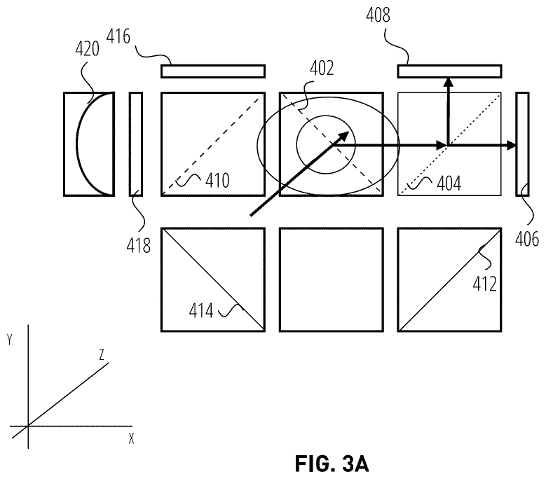

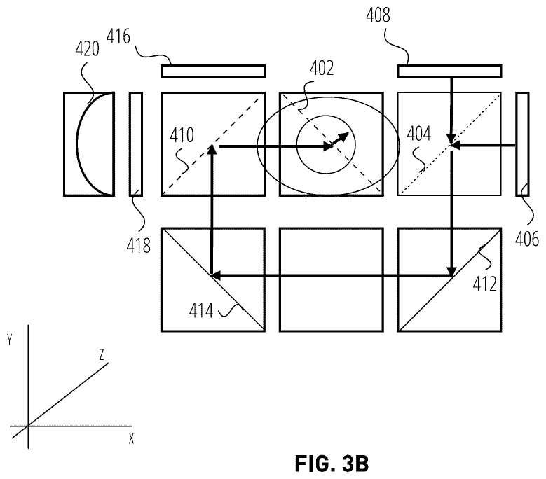

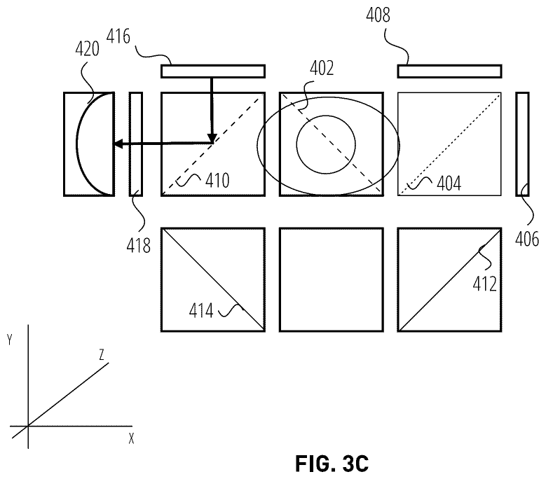

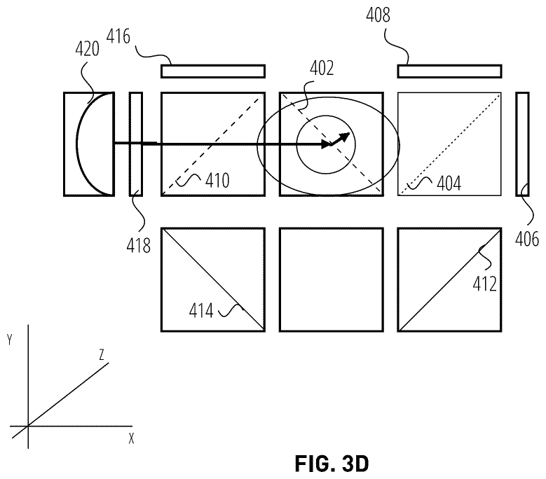

Referring to FIG. 3A-FIG. 3D, incident light may intercepted by a polarization beam splitter 402 (FIG. 3A). A portion of the light, e.g., 50%, is passed through to the viewer's pupil. Another portion of the incident light is reflected to a beam splitter 404 (e.g., a half-mirror), which passes a portion of the light to an SLM 406 and reflects another portion of the light to a mirror 408. The mirror 408 and SLM 406 are configured at equalized distances along perpendicular directions, forming a Michelson interferometer. Due to the effects of the polarization beam splitter 402, the light reaching these elements has a single polarization mode.

In FIG. 3B, the SLM 406 applies a phase shift to a portion of the incident light to occlude and reflects the incident light; the light that reaches the SLM 406 (including any phase shifted portions) is reflected by the SLM 406 back to the beam splitter 404. The mirror 408 also reflect the light that reached it back to the beam splitter 404 where the combined reflected beams interfere with one another. The SLM 406 may apply a sufficient phase shift to generate fully or partially destructive interference in the regions of the incident light to occlude or partially occlude. The combined beam, which now has a single polarization, is routed to a polarization beam splitter 410 in the depicted example using a mirror 412 and another mirror 414. The polarization beam splitter 410 reflects the light to the polarization beam splitter 402, which reflects the light into the viewer's pupil. The viewer sees the image generated by the incident light with particular regions occluded. The viewer does not experience double-imaging due to the very short distance traveled by the light reflected by the polarization beam splitter 402 and the very high propagation speed of light.

The 2D display 416 may also generate images. Referring to FIG. 3C and FIG. 3D, light from the 2D display 416 is reflected by the polarization beam splitter 410, through the quarter wave plate 418, and into the concave mirror 420.

A quarter wave plate 418 may be utilized to shift the phase of incident light waves by one-quarter of a wavelength (λ/4). This phase shift results in the alteration of the polarization state of the light passing through it. Typically made from birefringent materials (materials in which light travels at different speeds along different axes), the quarter wave plate 418 may comprise two principal axes: the ordinary axis and the extraordinary axis. When linearly polarized light, with its polarization direction at a 45-degree angle to these axes, passes through the quarter wave plate 418, it emerges as circularly polarized light. If the input light is circularly polarized, it will exit as linearly polarized light with the polarization direction depending on the handedness (right or left circular polarization) of the incoming light and the orientation of the quarter wave plate 418. The resulting polarization adjustment enables the light reflected from the concave mirror 420 to pass the polarization beam splitter 410 and be redirected by the polarization beam splitter 402 into the viewer's pupil.

The concave mirror 420 may change the scale of the image and reflect the light back to the polarization beam splitter 402, which then reflects the light into the viewer's eye, where it combines with the occluded image generated per FIG. 3A-FIG. 3B.

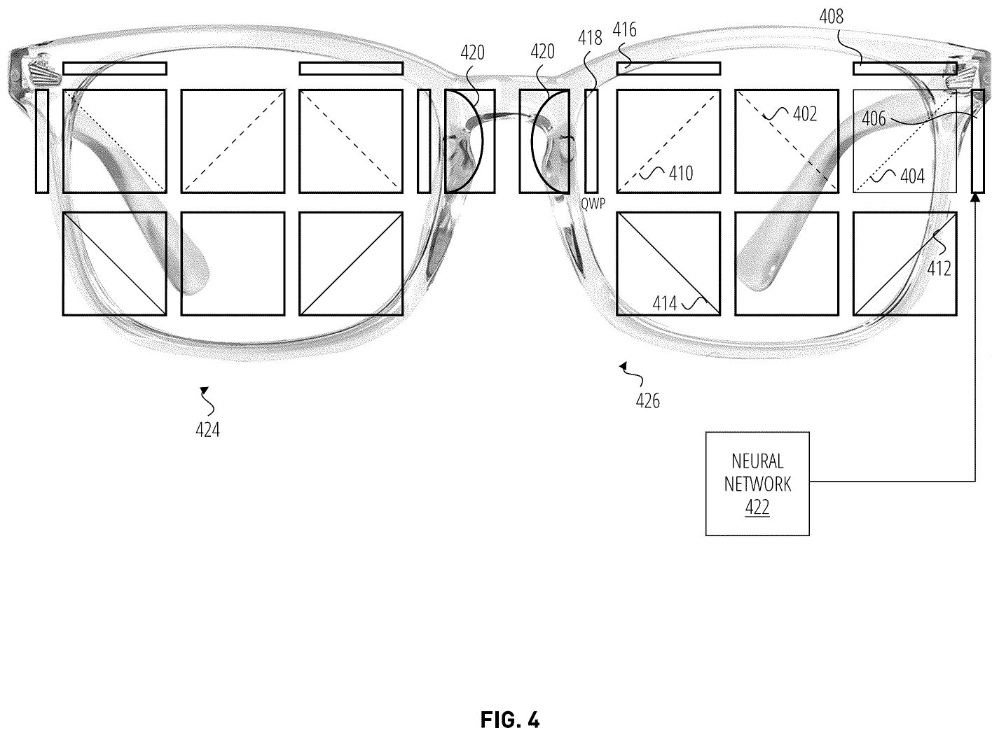

FIG. 4 depicts the elements of the optical system embodiment depicted in FIG. 3A-FIG. 3D deployed in a head-mounted display apparatus, with a neural network 422 trained to drive the SLM 406 in accordance with the mechanisms previously described. A single neural network 422 may be utilized to drive the SLM 406 for both of the viewer's pupils, or separately trained SLMs may be utilized for each pupil.

The head-mounted device implements an augmented reality display including a first viewport region 424 and a second viewport region 426 each including a light input region (delineated region containing polarization beam splitter 402) configured to align with a different eye of a user of the device. An interferometer including an SLM 406 is located in a first peripheral region positioned at a lateral offset in a first direction from the light input region.

Each viewport region 424, 426 includes a first light guide configured to direct incoherent light through the polarization beam splitter 402 located in the light input region to the interferometer located in the first peripheral region to generate an interference light pattern, and to direct the interference light pattern back to the polarization beam splitter 402 (e.g., via one or more mirrors). Each viewport region 424, 426 also includes a second light guide located in a second peripheral region of the light input region, the second light guide configured to direct second incoherent light from a two-dimensional display to the polarization beam splitter 402.

### LISTING OF DRAWING ELEMENTS

102 spatial light modulator
104 wavefronts
106 region
108 interferometer
110 mirror
112 half-mirror
114 camera
116 target region
118 occluded image region
202 convolution layer
204 convolution layer
206 convolution layer
208 pooling layer
210 pooling layer
212 pooling layer
214 deconvolution layer
216 deconvolution layer
218 deconvolution layer
220 concatenation layer
222 concatenation layer
224 concatenation layer
402 polarization beam splitter
404 beam splitter
406 SLM
408 mirror
410 polarization beam splitter
412 mirror
414 mirror
416 2D display
418 quarter wave plate
420 concave mirror
422 neural network
424 viewport region
426 viewport region

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A head-mounted optical system comprising:
an interferometer comprising a spatial light modulator; and
a first light guide comprising a first beam splitter;
the first light guide configured to:
direct incoherent light through the first beam splitter to the interferometer to generate an interference light pattern; and
direct the interference light pattern back to the first beam splitter.

2. The head-mounted optical system of claim 1, the first beam splitter comprising a polarization beam splitter.

3. The head-mounted optical system of claim 1, the interferometer comprising a Michelson interferometer.

4. The head-mounted optical system of claim 1, further comprising:
a second beam splitter disposed along the first light guide between the plurality of mirrors and the first beam splitter.

5. The head-mounted optical system of claim 4, the second beam splitter comprising a polarization beam splitter.

6. The head-mounted optical system of claim 4, further comprising a two-dimensional display.

7. The head-mounted optical system of claim 6, further comprising:
a second light guide comprising the second polarization beam splitter, a concave mirror and a quarter wave plate, the second light guide configured to receive incoherent light from the two-dimensional display.

8. The head-mounted optical system of claim 7, configured such that light from the first light guide and light from the second light guide merge at the second beam splitter.

9. The head-mounted optical system of claim 1, further comprising:
a neural network configured to generate phase settings for the spatial light modulator.

10. The head-mounted optical system of claim 9, the neural network comprising a U-Net structure.

11. An augmented reality display device comprising:
a first viewport region and a second viewport region each comprising:
an incoherent light input region configured to align with a different eye of a user of the head-mounted augmented reality display device; and
a peripheral region positioned at a lateral offset from the light input region;
each viewport region comprising:
a first light guide configured to direct the incoherent light through a first beam splitter located in the light input region to an interferometer located in the peripheral region to generate an interference light pattern; and
direct the interference light pattern back to the first beam splitter.

12. The augmented reality device of claim 11, the first beam splitter comprising a polarization beam splitter.

13. The augmented reality device of claim 11, the interferometer comprising a Michelson interferometer.

14. The augmented reality device of claim 11, further comprising:
the first light guide comprising at least one mirror; and
a second beam splitter disposed along the first light guide between the at least one mirror and the first beam splitter.

15. The augmented reality device of claim 14, the second beam splitter comprising a polarization beam splitter.

16. The augmented reality device of claim 14, further comprising a two-dimensional display.

17. The augmented reality device of claim 16, further comprising:
a second light guide comprising the second polarization beam splitter, a concave mirror and a quarter wave plate, the second light guide configured to receive incoherent light from the two-dimensional display.

18. The augmented reality device of claim 17, configured such that light from the first light guide and light from the second light guide merge at the second beam splitter.

19. The augmented reality device of claim 11, further comprising:
a neural network configured to generate phase settings for the spatial light modulator.

20. The augmented reality device of claim 19, the neural network comprising a U-Net structure.

21. An augmented reality display device comprising:
a first viewport region and a second viewport region each comprising:
a light input region configured to align with a different eye of a user of the head-mounted augmented reality display device;
a first peripheral region positioned at a lateral offset in a first direction from the light input region;
a second peripheral region positioned at a lateral offset in a second direction from the light input region;
each viewport region comprising:
a first light guide configured to direct first incoherent light through a beam splitter located in the light input region to an interferometer located in the first peripheral region to generate an interference light pattern, and direct the interference light pattern back to the first beam splitter; and
a second light guide located in the second peripheral region configured to direct second incoherent light from a two-dimensional display to the beam splitter.
